(19) United States
(12) Patent Application Publication
(10) Pub. No.: US 2017/0073512 A1
(43) Pub. Date: Mar. 16, 2017

(54) Seal Member

(71) Applicant: Kabushiki Kaisha Riken, Tokyo (JP)

(72) Inventors: Akihiro Oowada, Niigata (JP); Junichi Takahashi, Saitama (JP)

(21) Appl. No.: 15/267,205

(22) Filed: Sep. 16, 2016

(30) Foreign Application Priority Data
Sep. 16, 2015 (JP) 2015-182715

(51) Int. Cl. C08L 27/12

(52) U.S. Cl. CPC C08L 27/12

(57) ABSTRACT

A seal member is made of a composite material. The composite material includes: any one of an acrylic elastomer, a hydrogenated nitrile elastomer, a fluorinated elastomer, and a fluorosilicone elastomer as a main component; and a particulate filler and a fibrous filler. The particulate filler has a mean particle diameter of 1.0 μm or more and 50 μm or less. The fibrous filler has a mean diameter of 5.0 μm or more and 20 μm or less and has a mean length of 0.1 mm or more and 8 mm or less. Content of the particulate filler is 10% by volume or more and 35% by volume or less, and content of the fibrous filler is 5% by volume or more and 15% by volume or less.

### CROSS REFERENCE TO RELATED APPLICATION

This application claims priority under 35 U.S.C. §119 to Japanese Patent Application No. 2015-182715, filed Sep. 16, 2015, which is hereby incorporated by reference in its entirety

### BACKGROUND

The present invention relates to a seal member that is used for a hydraulic machine.

There are known automobiles equipped with various hydraulic machines such as hydraulic-type continuously variable transmissions. In those hydraulic machines, seal rings for sealing oil are used. The seal ring is fitted to a shaft, which is inserted into a housing, and seals a gap between the housing and the shaft, for example.

The seal ring is desirably capable of coming into close contact with a housing and a shaft without any gap therebetween so as to achieve high sealing properties between the housing and the shaft. For that reason, the seal ring may be formed of an elastomer having rubber elasticity. Japanese Patent Application Laid-open Nos. 2012-255495 and 2013-194884 each disclose a seal ring formed of an elastomer.

### BRIEF SUMMARY

For example, in automobiles equipped with hydraulic machines, there is a demand for reduction in drive loss of the hydraulic machines so as to improve fuel efficiency.

The seal ring slides along the housing together with a reciprocating motion of the shaft to the housing, when the hydraulic machine is driven. As a result, in the hydraulic machine, a friction loss is caused. The friction loss is a drive loss due to a frictional force between the seal ring and the housing. Hence, in order to reduce the friction loss of the hydraulic machine, the seal ring desirably has high sliding properties.

However, an elastomer generally has high rubber elasticity but has a high friction coefficient. So, a seal ring formed of an elastomer provides high sealing properties but has a difficulty in providing high sliding properties.

In view of the circumstances as described above, it is desirable to provide a seal member having good sealing properties and good sliding properties.

According to an embodiment of the present invention, there is provided a seal member, which is made of a composite material. The composite material includes: any one of an acrylic elastomer, a hydrogenated nitrile elastomer, a fluorinated elastomer, and a fluorosilicone elastomer as a main component; and a particulate filler and a fibrous filler.

The particulate filler has a mean particle diameter of 1.0 μm or more and 50 μm or less. The fibrous filler has a mean diameter of 5.0 μm or more and 20 μm or less and has a mean length of 0.1 mm or more and 8 mm or less.

Content of the particulate filler is 10% by volume or more and 35% by volume or less, and content of the fibrous filler is 5% by volume or more and 15% by volume or less.

This configuration can provide a seal member having good sealing properties and good sliding properties.

The particulate filler and the fibrous filler may be exposed on a surface of the seal member.

This configuration can further provide a seal member having good sealing properties and good sliding properties.

The particulate filler may include at least one of a fluorine resin, amorphous carbon, graphite, and synthetic silica. Further, the fibrous filler may include at least one of a carbon fiber, an aramid fiber, and a phenol fiber.

This configuration can provide a seal member having good sealing properties and good sliding properties.

The composite material may have a compression set of 70% or less at 150° C.

This configuration can further provide a seal member having good sealing properties.

The composite material may have a dynamic friction coefficient of 0.3 or less in oil.

This configuration can further provide a seal member having good sliding properties.

The seal member may be formed into a ring shape.

This configuration can provide a seal member having good sealing properties and good sliding properties.

According to the present invention, it is possible to provide a seal member having good sealing properties and good sliding properties.

These and other objects, features and advantages of the present invention will become more apparent in light of the following detailed description of embodiments thereof, as illustrated in the accompanying drawings.

### BRIEF DESCRIPTION OF DRAWING

FIG. 1 is a plan view of a seal ring according to an embodiment of the present invention.

### DETAILED DESCRIPTION

Hereinafter, an embodiment of the present invention will be described with reference to the drawings.

### 1. Overall Configuration of Seal Ring 1

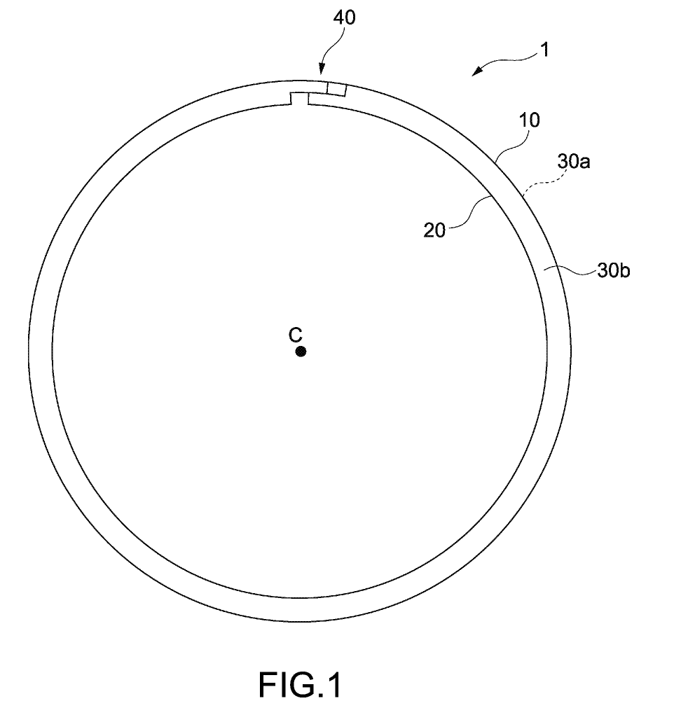

FIG. 1 is a plan view of a seal ring 1 according to an embodiment of the present invention. The seal ring 1 is formed into a ring shape centering on a central axis C. The seal ring 1 includes an outer circumferential surface 10, an inner circumferential surface 20, and side surfaces 30a and 30b that connect the outer circumferential surface 10 and the inner circumferential surface 20 to each other.

The seal ring 1 includes a joint 40 for facilitating fitting to a shaft as needed. The shape of the joint may be a straight shape, a double angle shape, or a triple stepped shape, for example.

The seal ring 1 can be used for a hydraulic machine such as a hydraulic-type continuously variable transmission mounted to an automobile. The seal ring 1 is fitted to a shaft, which is inserted into a housing of a hydraulic machine, and seals a gap between the housing and the shaft. The shaft inserted into the housing relatively reciprocates with respect to the housing.

At that time, the outer circumferential surface 10 of the seal ring 1 fitted to the shaft slides relatively in a direction of the central axis C along the inner circumferential surface of the housing. In other words, in the seal ring 1, a sliding surface, which is a mating material for the housing, is the outer circumferential surface 10. The seal ring 1 has a configuration capable of effectively reducing a friction loss between the outer circumferential surface 10 and the housing, as described below.

### 2. Detailed Configuration of Seal Ring 1

The seal ring 1 includes a composite material containing a base material and fillers. The base material is an elastomer. The fillers are a particulate filler and a fibrous filler. The particulate filler and the fibrous filler are uniformly dispersed in the elastomer.

Providing the particulate filler and the fibrous filler in the composite material of the seal ring 1 can improve a tensile strength while improving sliding properties of the elastomer, and can also ensure good formability.

The elastomer is not limited to a specific type. The elastomer desirably has good heat resistance and oil resistance, and a small compression set. Specifically, a heatproof temperature of the elastomer is desirably 180° C. or higher. Further, the elastomer desirably has a coefficient of volume expansion of 10% or less in an immersion to a continuously variable transmission fluid (CVTF) at 150° C. for 1,000 hours. Furthermore, the elastomer desirably has a compression set (177° C., 22 hours) of 30% or less.

In this embodiment, a fluorinated elastomer is used as an elastomer that meets the above conditions. Examples of a usable fluorinated elastomer include “SIFEL3000 Series” manufactured by Shin-Etsu Chemical Co., Ltd., “Diel G-101” manufactured by Daikin Industries, Ltd., “CEFRAL SOFT” manufactured by Central Glass Co., Ltd., “THV” manufactured by Sumitomo 3M Limited, and “AFLAS” manufactured by Asahi Glass Co., Ltd.

Further, examples of a usable elastomer include, in addition to the fluorinated elastomer, an acrylic elastomer, a hydrogenated nitrile elastomer, and a fluorosilicone elastomer.

The particulate filler is not limited to a specific type and may include one type or a plurality of types of fillers. As the particulate filler, for example, at least one of a fluorine resin, amorphous carbon, graphite, and synthetic silica can be used.

The fibrous filler is not limited to a specific type and may include one type or a plurality of types of fillers. As the fibrous filler, for example, at least one of a carbon fiber, a glass fiber, an aramid fiber, and a phenol fiber can be used.

The particulate filler and the fibrous filler are exposed on the outer circumferential surface 10 that is the sliding surface of the seal ring 1. In other words, the particulate filler and the fibrous filler protrude from the outer circumferential surface 10. The particulate filler and the fibrous filler exposed on the outer circumferential surface 10 are partially held by the elastomer and thus fixed to the outer circumferential surface 10.

With this configuration, when the outer circumferential surface 10 of the seal ring 1 slides with respect to the housing, the particulate filler and the fibrous filler exposed on the outer circumferential surface 10 come into contact with the housing, so that an oil film is formed between the elastomer and the housing. In other words, on the outer circumferential surface 10 of the seal ring 1, the particulate filler and the fibrous filler prevent the elastomer and the housing from coming into direct contact with each other. This can reduce a friction loss between the seal ring 1 and the housing.

Further, in the seal ring 1, since the elastomer and the housing are prevented from coming into direct contact with each other, good abrasion resistance of the outer circumferential surface is also obtained.

A mean diameter of the particulate filler is desirably set to 1.0 μm or more and 50 μm or less. When the mean diameter of the particulate filler is set to 1.0 μm or more, the amount of protrusion on the outer circumferential surface 10 is increased. Thus, a friction loss can be reduced more effectively. Further, when the mean diameter of the particulate filler is set to 50 μm or less, a mechanical strength and hardness of the seal ring 1 are further improved.

A mean diameter (mean thickness) of the fibrous filler is desirably set to 5.0 μm or more and 20 μm or less. When the mean diameter of the fibrous filler is set to 5.0 μm or more, the amount of protrusion on the outer circumferential surface 10 is increased. Thus, a friction loss can be reduced more effectively. Further, when the mean diameter of the fibrous filler is set to 20 μm or less, a mechanical strength and hardness of the seal ring 1 are further improved.

A mean length of the fibrous filler is desirably set to 0.1 mm or more and 8 mm or less. When the mean length of the fibrous filler is set to 0.1 mm or more and 8 mm or less, property of a fiber is successfully obtained. Thus, a mechanical strength and hardness of the seal ring 1 are further improved.

In the seal ring 1, as content of the particulate and fibrous fillers is larger, the sliding properties increase but the sealing properties decrease. In this embodiment, the content of the fibrous filler in the composite material forming the seal ring 1 is determined such that the sliding properties and the sealing properties can be compatible with each other and formability and a tensile strength can be compatible with each other.

Specifically, when a compression set of the seal ring 1 at 150° C. is 70% or less, high sealing properties of the seal ring 1 can be ensured. Further, when a dynamic friction coefficient in oil of the seal ring 1 in the direction of the central axis C is 0.3 or less, high sliding properties of the seal ring 1 can be ensured.

Further, in the seal ring 1, when the content of the particulate filler is too high, a tensile strength decreases. Meanwhile, in the seal ring 1, when the content of the fibrous filler is too high, the formability decreases. In this regard, in the seal ring 1 according to this embodiment, the particulate filler and the fibrous filler are used in combination, so that good sliding properties are obtained while the content of the particulate filler and the content of the fibrous filler are suppressed.

As described above, in the composite material, the content of the particulate filler is set to 10% by volume or more and 35% by volume or less, and the content of the fibrous filler is set to 5% by volume or more and 15% by volume or less. When the content of the particulate filler is set to 10% by volume or more and the content of the fibrous filler is set to 5% by volume or more, the sliding properties are improved. Further, when the content of the particulate filler is set to 35% by volume or less and the content of the fibrous filler is set to 10% by volume or less, increase in compression set can be suppressed and decrease in formability and tensile strength can also be suppressed.

The seal ring 1 formed of the composite material as described above has sufficiently low dynamic friction coefficient and compression set and has sufficiently high tensile strength and hardness. So, the seal ring 1 having good sliding properties and good formability can be obtained while maintaining a sufficient mechanical strength.

### 3. Method of Producing Seal Ring 1

Hereinafter, exemplary methods of producing the seal ring 1 by thermosetting and injection molding will be described. It should be noted that the method of producing the seal ring 1 is not limited to those examples.

3.1 Thermosetting

In the case where a thermosetting fluorinated elastomer is used as a base material, first, polytetrafluoroethylene (PTFE) powder (particulate filler) and an aramid fiber (fibrous filler) are added to a fluorinated elastomer paste (liquid) that is not hardened. The fluorinated elastomer, the PTFE powder (particulate filler), and the aramid fiber (fibrous filler) are then sufficiently kneaded to obtain a kneaded mixture. The kneaded mixture obtained is injected into a mold, and the mold is then heated, so that the kneaded mixture within the mold is hardened. After the mold is cooled, a seal ring 1 is obtained from the mold.

3.2 Injection Molding

In the case where a thermoplastic fluorinated elastomer is used as a base material, first, PTFE powder (particulate filler) and an aramid fiber (fibrous filler) are added to a fluorinated elastomer, and the fluorinated elastomer, the PTFE powder (particulate filler), and the aramid fiber (fibrous filler) are sufficiently kneaded to obtain a kneaded mixture. The kneaded mixture obtained is heated, and the kneaded mixture softened is then charged into a mold. After the mold is cooled, a seal ring 1 is obtained from the mold.

### 4. Examples

Hereinafter, Examples of the above embodiment will be described, but the present invention is not limited to Examples below.

4.1 Production of Seal Ring 1

In Examples, “SIFEL3705A/B” having high a Shore A hardness and good pressure resistance, which is manufactured by Shin-Etsu Chemical Co., Ltd., was used for the fluorinated elastomer. The fluorinated elastomer is a two-component type thermosetting paste.

For the particulate filler used in Examples, a mean particle diameter of PTFE powder was set to 8 μm, a mean particle diameter of graphite powder was set to 35 μm, and a mean particle diameter of synthetic silica powder was set to 22 μm. For the fibrous filler used in Examples, a mean diameter of an aramid fiber was set to 12 μm, and a mean length thereof was set to 1 mm. A mean diameter of a carbon fiber was set to 13 μm, and a mean length thereof was set to 0.7 mm. A mean diameter of a glass fiber was set to 11 μm, and a mean length thereof was set to 150 μm.

In Examples 1 to 4, content of the fibrous filler was set to 7% by volume, and content of the particulate filler was changed to 15, 20, 30, and 35% by volume. In Examples 5 to 7, the content of the particulate filler was set to 30% by volume, and the content of the fibrous filler was changed to 5, 10, and 15% by volume. In Examples 1 to 7, the PTFE powder was used for the particulate filler, and the aramid fiber was used for the fibrous filler.

In Examples 8 to 11, the seal rings 1 were produced, with the content of the particulate filler being set to 30% by volume and the content of the fibrous filler being set to 7% by volume, by changing combination of the particulate filler and the fibrous filler. In Examples 8 and 9, the PTFE powder was used for the particulate filler, and the carbon fiber and the glass fiber were used for the fibrous filler, respectively. In Examples 10 and 11, the aramid fiber was used for the fibrous filler, and the graphite powder and the synthetic silica powder were used for the particulate filler, respectively.

The seal rings 1 according to Examples 1 to 11 described above were produced by a method similar to the following method. In Example 1, first, a one-component fluorinated elastomer, a two-component fluorinated elastomer, the PTFE powder, and the aramid fiber were kneaded. In the kneading, the fluorinated elastomers, the PTFE powder, and the aramid fiber only need to be successfully mixed. The kneading may be performed with a kneading machine or performed manually.

Next, a kneaded mixture obtained in the kneading was charged into a mold for a seal ring, and the mold was heated. The heating of the mold was held at 150° C. for 5 to 10 minutes. As a result, a seal ring 1 having an outer diameter of 125.0 mm, an inner diameter of 119.0 mm, and a width of 3.0 mm was obtained.

Further, by a method similar to the method in Examples described above, a seal ring 1 containing no particulate and fibrous fillers was produced for Comparative Example 1, a seal ring 1 containing only the particulate filler was produced for Comparative Example 2, a seal ring 1 containing only the fibrous filler was produced for Comparative Example 3, and seal rings 1 having the content of the particulate filler out of the range of the above embodiment were produced for Comparative Examples 4 to 7.

Specifically, in Comparative Examples 4 and 5, the content of the particulate filler is out of the range of the above embodiment, and in Comparative Examples 6 and 7, the content of the fibrous filler is out of the range of the above embodiment.

In Comparative Examples 4 to 7, the PTFE powder was used for the particulate filler, and the aramid fiber was used for the fibrous filler.

4.2 Evaluation of Seal Ring 1

In order to evaluate the seal ring 1, a dynamic friction coefficient, a Shore A hardness, a compression set, and a tensile strength were measured. It should be noted that the dynamic friction coefficient, the compression set, and the tensile strength are difficult to measure using the seal ring 1 as it is, and thus measurement samples having performance similar to the performance of the seal ring 1 were produced.

4.2.1 Measurement of Dynamic Friction Coefficient

Test pieces having a length of 100 mm, a width of 10 mm, and a thickness of 3 mm were produced as measurement samples in this measurement. The measurement samples were subjected to a reciprocating friction and wear test under the following conditions: in oil at 100° C.; a surface pressure of 1.0 MPa; a measuring rate of 10 mm/second; a measuring length of 10 mm; and the number of strokes of 100, with use of the TriboGear TYPE38 manufactured by Shinto Scientific Co., Ltd.

For evaluation criteria of measurement results on the dynamic friction coefficient, measurement samples that obtained good results providing the dynamic friction coefficient of 0.3 or less were determined as “A”, and measurement samples that obtained poor results providing the dynamic friction coefficient exceeding 0.3 were determined as “B”.

4.2.2 Measurement of Shore A Hardness

Measurement samples in this measurement were produced by cutting out each seal ring 1 into an appropriate shape. The measurement samples were measured for the Shore A hardness on the basis of JIS K7215 with use of a Type-A durometer.

For evaluation criteria of measurement results on the Shore A hardness, measurement samples that obtained good results providing the Shore A hardness of 80 or more were determined as “A”, and measurement samples that obtained poor results providing the Shore A hardness of less than 80 were determined as “B”.

4.2.3 Measurement of Compression Set

Test pieces having a length of 5 mm, a width of 15 mm, and a thickness of 2 mm, which were obtained by injection molding, were used for measurement samples in this measurement.

In the measurement, first, a measurement sample sandwiched between spacers was compressed by 25% by a pressurizing force applied between the spacers and was held at 150° C. for 100 hours. Subsequently, the pressurizing force applied between the spacers was released, and the measurement sample was left at room temperature for 30 minutes. A compression set at 150° C. was calculated by the following expression.

(Compression set at 150° C.)=[(t₀−t₂)/t₀−t₁]×100[%]

(where t₀ represents a thickness (mm) of the measurement sample before being subjected to the test, t₁ represents a thickness (mm) of the spacer, and t₂ represents a thickness (mm) of the measurement sample after being subjected to the test (after being left at room temperature for 30 minutes).)

For evaluation criteria of measurement results on the compression set, measurement samples that obtained good results providing the compression set of 70% or less were determined as “A”, and measurement samples that obtained poor results providing the compression set exceeding 70% were determined as “B”.

4.2.4 Measurement of Tensile Strength

Measurement was performed on the basis of JIS K6251. Measurement samples were produced in a shape of a JIS No. 3 dumbbell and measured at a tensile rate of 500 mm/minute.

For evaluation criteria of measurement results on the tensile strength, measurement samples that obtained good results providing the tensile strength of 10 MPa or more were determined as “A”, and measurement samples that obtained poor results providing the tensile strength of less than 10 MPa were determined as “B”.

4.2.5 Evaluation Results

Table 1 shows evaluation results of the seal rings 1 according to Examples 1 to 11 and Comparative Examples 1 to 7.

TABLE 1

| | Filling | Filling | Filling | | | | | | | |
|---|---|---|---|---|---|---|---|---|---|---|
| | amount | amount | amount of | | | | Dynamic | | | |
| | of | of | synthetic | | | | friction | | Com- | |
| | PTFE | graphite | silica | Aramid | Carbon | Glass | coeffi- | | pression | Tensile |
| | powder | powder | powder | fiber | fiber | fiber | cient | Shore A | set | strength |
| | (vol %) | (vol %) | (vol %) | (vol %) | (vol %) | (vol %) | μ | hardness | (%) | (MPa) |
| Example 1 | 15 | | | 7 | | | A | A | A | A |
| Example 2 | 20 | | | 7 | | | A | A | A | A |
| Example 3 | 30 | | | 7 | | | A | A | A | A |
| Example 4 | 35 | | | 7 | | | A | A | A | A |
| Example 5 | 30 | | | 5 | | | A | A | A | A |
| Example 6 | 30 | | | 10 | | | A | A | A | A |
| Example 7 | 30 | | | 15 | | | A | A | A | A |
| Example 8 | 30 | | | | 7 | | A | A | A | A |
| Example 9 | 30 | | | | | 7 | A | A | A | A |
| Example 10 | | 30 | | 7 | | | A | A | A | A |
| Example 11 | | | 30 | 7 | | | A | A | A | A |
| Comparative | | | | | | | B | B | A | B |
| Example 1 | | | | | | | | | | |
| Comparative | 30 | | | | | | A | A | A | B |
| Example 2 | | | | | | | | | | |
| Comparative | | | | 7 | | | B | A | A | A |
| Example 3 | | | | | | | | | | |
| Comparative | 5 | | | 7 | | | B | A | A | A |
| Example 4 | | | | | | | | | | |
| Comparative | 40 | | | 7 | | | A | A | B | B |
| Example 5 | | | | | | | | | | |
| Comparative | 30 | | | 2 | | | A | A | A | B |
| Example 6 | | | | | | | | | | |
| Comparative | 30 | | | 20 | | | A | A | B | A |
| Example 7 | | | | | | | | | | |

As shown in Table 1, the seal rings 1 according to Examples 1 to 11 obtained good results in all the measurements. In contrast to this, the seal rings 1 according to Comparative Examples 1 to 7 obtained poor results in any one of the evaluation items.

More specifically, according to Comparative Example 1, the seal ring 1 containing no particulate and fibrous fillers did not obtain good results on the dynamic friction coefficient, the Shore A hardness, and the tensile strength. This resulted in that the seal ring 1 formed only of an elastomer provides sliding properties, hardness, and mechanical strength inferior to those of the seal rings 1 according to Examples 1 to 11.

Further, according to Comparative Example 2, the seal ring 1 containing no fibrous filler but containing a particulate filler did not obtain a good result on the tensile strength. This resulted in that the seal ring 1 containing no fibrous filler provides a mechanical strength inferior to those of the seal rings 1 according to Examples 1 to 11.

Furthermore, according to Comparative Example 3, the seal ring 1 containing no particulate filler but containing a fibrous filler did not obtain a good result on the dynamic friction coefficient. This resulted in that the seal ring 1 containing no particulate filler provides sliding properties inferior to those of the seal rings 1 according to Examples 1 to 11.

According to Comparative Example 4, the seal ring 1 having smaller content of the particulate filler than the range of the above embodiment did not obtain a good result on the dynamic friction coefficient. This resulted in that the seal ring 1 having smaller content of the particulate filler provides sliding properties inferior to those of the seal rings 1 according to Examples 1 to 11.

According to Comparative Example 5, the seal ring 1 having larger content of the particulate filler than the range of the above embodiment did not obtain good results on the compression set and the tensile strength. This resulted in that the seal ring 1 having larger content of the particulate filler provides sealing properties and a mechanical strength inferior to those of the seal rings 1 according to Examples 1 to 11.

According to Comparative Example 6, the seal ring 1 having smaller content of the fibrous filler than the range of the above embodiment did not obtain a good result on the tensile strength. This resulted in that the seal ring 1 having smaller content of the fibrous filler provides a mechanical strength inferior to those of the seal rings 1 according to Examples 1 to 11.

According to Comparative Example 7, the seal ring 1 having larger content of the fibrous filler than the range of the above embodiment did not obtain a good result on the compression set. This resulted in that the seal ring 1 having larger content of the fibrous filler provides sealing properties inferior to those of the seal rings 1 according to Examples 1 to 11. Further, the seal ring 1 having larger content of the fibrous filler hardly obtained a correct shape due to reduction in formability.

### 5. Others

Hereinabove, the embodiment of the present invention has been described. The present invention is not limited to the above embodiment but can be variously modified without departing from the gist of the present invention.

For example, the seal ring 1 according to this embodiment is formed only of an elastomer, a particulate filler, and a fibrous filler. However, as long as the seal ring 1 mainly contains an elastomer, a particulate filler, and a fibrous filler, the present invention can be achieved also when the seal ring 1 contains accessory components such as various additives.

Further, the present invention can be applied to all the seal members used for hydraulic machines. Hence, the seal member is not limited to a seal ring and may have any shape. A seal member having any shape can provide effects similar to those in the above embodiment.

What is claimed is:

1. A seal member, which is made of a composite material, the composite material comprising:
any one of an acrylic elastomer, a hydrogenated nitrile elastomer, a fluorinated elastomer, and a fluorosilicone elastomer as a main component; and
a particulate filler and a fibrous filler,
the particulate filler having a mean particle diameter of 1.0 μm or more and 50 μm or less, the fibrous filler having a mean diameter of 5.0 μm or more and 20 μm or less and having a mean length of 0.1 mm or more and 8 mm or less,
content of the particulate filler being 10% by volume or more and 35% by volume or less, content of the fibrous filler being 5% by volume or more and 15% by volume or less.

2. The seal member according to claim 1, wherein
the particulate filler and the fibrous filler are exposed on a surface of the seal member.

3. The seal member according to claim 1, wherein
the particulate filler includes at least one of a fluorine resin, amorphous carbon, graphite, and synthetic silica, and
the fibrous filler includes at least one of a carbon fiber, an aramid fiber, and a phenol fiber.

4. The seal member according to claim 1, wherein
the composite material has a compression set of 70% or less at 150° C.

5. The seal member according to claim 1, wherein
the composite material has a dynamic friction coefficient of 0.3 or less in oil.

6. The seal member according to claim 1, which is formed into a ring shape.
